(19) United States
(12) Patent Application Publication
(10) Pub. No.: US 2017/0284463 A1
(43) Pub. Date: Oct. 5, 2017

(54) Device For Magnetically Supporting A Shaft

(71) Applicant: Siemens Aktiengesellschaft, Muenchen (DE)

(72) Inventors: Dirk Diehl, Bubenreuth (DE); Robert Goraj, Erlangen (DE)

(73) Assignee: Siemens Aktiengesellschaft, Muenchen (DE)

(21) Appl. No.: 15/507,493

(22) PCT Filed: Aug. 18, 2015
(86) PCT No.: PCT/EP2015/068903

§ 371 Date: Feb. 28, 2017

(30) Foreign Application Priority Data
Sep. 4, 2014 (DE) 102014 217684.0

(51) Int. Cl. F16C 32/04

(52) U.S. Cl. CPC F16C 32/0461; F16C 32/0474; F16C 32/0465; F16C 32/0444

(57) ABSTRACT

A device for supporting a shaft may include a magnetic yoke that surrounds the shaft and has the shape of a U-section, and at least one first element for creating a magnetic circuit that can be formed from the magnetic yoke to the shaft. The shaft may be eccentrically supported in the surrounding magnetic yoke in such a way that a first vertical upper distance between the shaft and the magnetic yoke is smaller a second vertical lower distance between the shaft and the magnetic yoke.

### CROSS-REFERENCE TO RELATED APPLICATIONS

This application is a U.S. National Stage Application International Application No. PCT/EP2015/068903 filed Aug. 18, 2015, which designates the United States of America, and claims priority to DE Application No. 10 2014 217 684.0 filed Sep. 4, 2014, the contents of which are hereby incorporated by reference in their entirety.

### TECHNICAL FIELD

The invention relates to a device for magnetically supporting a shaft.

### BACKGROUND

The supporting of rotating shafts can take place with the aid of plain bearings or roller bearings. For high bearing forces and rotary speeds and for very large bearing diameters or shaft diameters, in particular, the hydrodynamic plain bearing is suitable. The load-carrying capacity of the bearing is usually proportional to the rotating mass that must be borne. Only during running up and running down, the hydrodynamic bearing is disadvantageously loaded such that wear phenomena occur. Also disadvantageous is the additional effort created for manufacturing and maintenance as compared with roller bearings, for example, the oil change.

### SUMMARY

One embodiment provides a device for supporting a shaft, the device comprising a magnet yoke surrounding the shaft and having a U-profile, wherein an opening of the U-profile faces toward the shaft, and at least one first element configured to generate a magnetic circuit from the magnet yoke to the shaft, wherein the shaft is mounted eccentrically in the surrounding magnet yoke such that a first vertical upper spacing between the shaft and the magnet yoke is smaller than a second vertical lower spacing between the shaft and the magnet yoke.

In one embodiment, the at least one first element comprises a ring-shape coil arranged within the opening of the U-profile of the magnet yoke around the shaft.

In one embodiment, the at least one first element comprises first and second permanent magnets that attach to first and second radially arranged limbs, respectively, of the U-profile of the magnet yoke.

In one embodiment, a poling of the first permanent magnet at the first limb are opposed to a poling of the second permanent magnet at the second limb.

In one embodiment, the device comprises a second element configured to displace the magnet yoke relative to the shaft.

In one embodiment, the second element is firmly attached to the magnet yoke.

In one embodiment, the first vertical upper spacing and the second vertical lower spacing are filled with a fluid.

In one embodiment, the first vertical upper spacing and the second vertical lower spacing are filled with air.

In one embodiment, the device comprises a control unit configured to regulate the magnetic circuit, and adjust the first vertical upper spacing and the second vertical lower spacing.

### BRIEF DESCRIPTION OF THE DRAWINGS

Example aspects and embodiments of the invention are discussed in detail below with reference to the accompanying drawings, in which:

FIG. 1 is the side view of a magnet yoke with a shaft and an alignment device;

FIG. 2 is a sectional view through the magnet yoke with the coil and the shaft;

FIG. 3 is a side view of the magnet yoke with the permanent magnets, the shaft and the alignment device;

FIG. 4 is a sectional view of the magnet yoke with the permanent magnet and the shaft.

### DETAILED DESCRIPTION

Embodiments of the present invention provide a device for mounting a shaft which overcomes the disadvantages mentioned.

Some embodiment provide a device for mounting a shaft that comprises a magnet yoke surrounding the shaft and having a U-profile, the opening of the U-profile facing toward the shaft. It further comprises at least one first means for generating a magnetic circuit, wherein the magnetic circuit can be formed from the magnet yoke to the shaft. Herein, the shaft is mounted eccentrically in the surrounding magnet yoke such that a first vertical upper spacing between the shaft and the magnet yoke is smaller than a second vertical lower spacing between the shaft and the magnet yoke.

Vertically below and vertically above relate to the gravitation acting at the location. By means of the magnetic circuit and the different spacings between the shaft and the magnet yoke, the bearing is relieved of loading since a force forms which acts against gravity at the respective site of the mounting. The bearing is thus less loaded by the weight of the shaft even during the running up of the bearing, as a result of which wear phenomena are reduced. During the operation of the bearing also, the bearing is relieved of loading. By this means, wear phenomena during operation also decrease advantageously and the maximum operational life increases. By means of the relief of the bearing during running up and during operation, the size of the bearing can advantageously be reduced. In this way, material of the bearing can advantageously be spared.

In one embodiment of the invention, the first means comprises a ring-shaped coil. This coil is arranged within the opening of the U-profile of the magnet yoke around the shaft. The magnetic circuit then forms, as described above, from the magnet yoke to the shaft and develops a force which acts against gravity. Advantageously, this force can already act before the start of the running of the bearing, so that a running up of the bearing is hydrostatically supported. The coil can be a copper coil or a superconducting coil. The superconducting coil can advantageously carry a greater weight, i.e. in particular heavy shafts.

In a further embodiment of the invention, the first means comprises at least one first and one second permanent magnet. These magnets attach to a first and a second radially arranged limb of the U-profile of the magnet yoke. Axially here denotes parallel to the shaft and radially denotes orthogonally to the shaft. Advantageously, before the running up of the bearing, a force is advantageously formed which acts in opposition to gravity. By this means, wear phenomena of the bearing are advantageously reduced.

In a further embodiment of the invention, the poling of the first permanent magnet at the first limb is opposed to the poling of the second permanent magnet at the second limb. Thereby, the magnetic circuit is formed from the magnet yoke to the shaft such that a force develops which acts against gravity. The bearing is thus advantageously relieved of load, and wear phenomena decrease.

In a further embodiment of the invention, the device comprises a second means for displacing the magnet yoke relative to the shaft. Advantageously, the arrangement of the shaft in the surrounding magnet yoke can thereby change such that the force of the magnetic circuit can act optimally opposed to gravity. Thermal expansions of the shaft can also be compensated for by means of a displacement.

In a further development of the invention, the second means is firmly connected to the magnet yoke. The displacement can thereby be carried out directly and immediately.

In a further embodiment of the invention, the first and the second separation between the magnet yoke and the shaft is filled with a fluid. Particularly advantageously, the fluid is air. This can be present in the bearing at ambient pressure or at negative pressure. Alternatively, the fluid can be a liquid.

In a further embodiment of the invention, the device comprises a control unit for regulating the magnetic circuit, the first and second spacing being adjustable by means of the control unit. Advantageously, by this means the thermal expansion of the shaft or oscillations of the shaft can be regulated. This advantageously also reduces wear phenomena of the bearing.

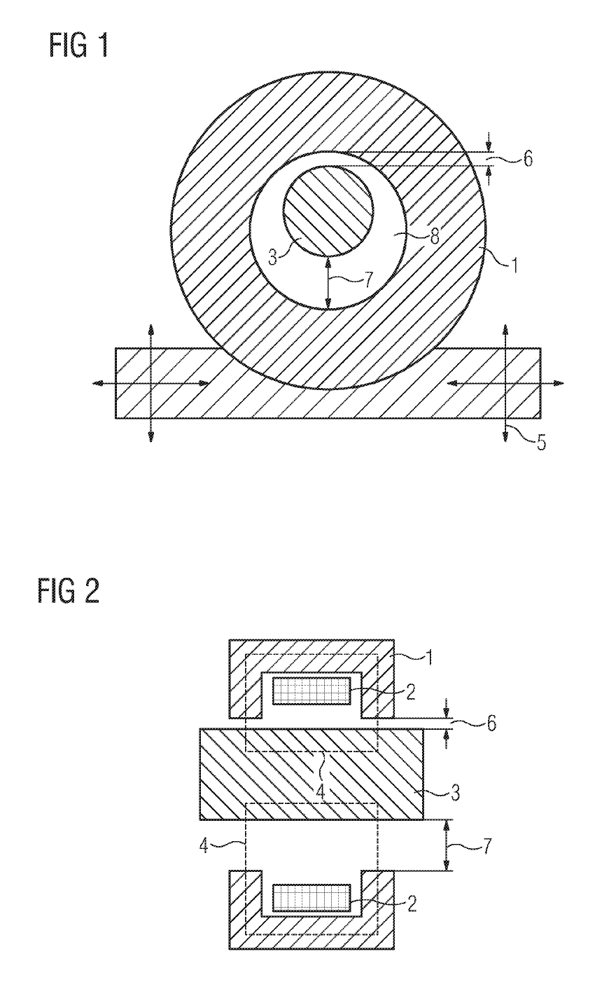

FIG. 1 shows a side view of a bearing for a shaft 3. The bearing comprises a magnet yoke 1, a coil 2, a shaft 3 and an alignment device 5. FIG. 1 illustrates that the magnet yoke 1 is arranged round the shaft 3. It is further made clear that a first spacing 6 between the shaft 3 and the magnet yoke 1 is smaller than a second spacing 7 between the shaft 3 and the magnet yoke 1. The coil 2 can be a copper coil or a superconducting coil. In the case of a copper coil, the first spacing 6 is typically 1 mm, in the case of the superconducting coil, the first spacing 6 is typically 1 mm to 5 mm. The second spacing 7 is, in particular, 80% of the first spacing 6. The diameter of the shaft 3 is, in particular, between 5 cm and 3 m. The outer diameter of the magnet yoke 1 is 20% to 30% larger than the diameter of the shaft 3.

FIG. 2 shows that the coil 2 is arranged within the U-profile of the magnet yoke 1. The magnetic circuit 4 is closed via the magnet yoke 1, the first spacing 6, in particular an air gap and the shaft 3. FIG. 2 also illustrates that the first spacing 6 is smaller than the second spacing 7. It is made clear by means of the magnetic circuits 4 that a magnetic force acts in opposition to gravity. This force relieves the bearing. In particular, during the running up of the bearing, the bearing is relieved so that wear phenomena are significantly reduced.

The shaft 3 is typically a ferromagnetic steel shaft. In order to prevent losses in the magnetic circuit 4 through eddy currents, the outer layer of the shaft 3 is configured as a laminated core.

This laminated core serves as an insulating layer and prevents the current flow. Alternatively, it is possible to configure the shaft from an electrically non-conducting or barely conducting material. Typically, fiber composite materials or high-grade steel are used as materials.

For the magnet yoke 1 and the alignment device 5, typically steel is used as the material.

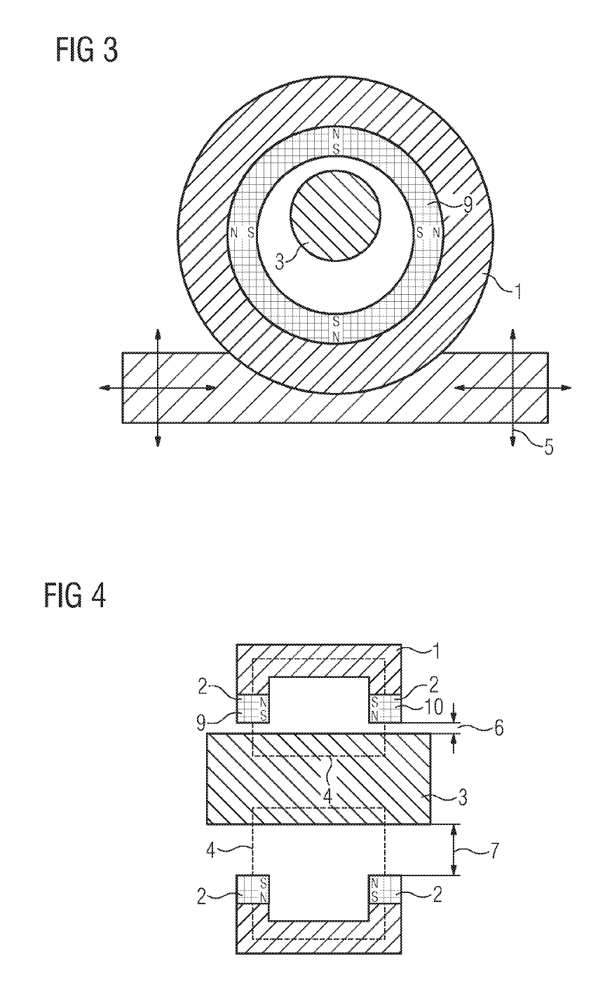

FIGS. 3 and 4 show a further embodiment of the bearing. It is shown in FIG. 3 that the bearing entirely encompasses the shaft in a ring-shaped manner. As distinct from FIGS. 1 and 2, the magnetic field is generated by permanent magnets 9, 10. It is evident from FIG. 4 that these permanent magnets 9, 10 are arranged such that they extend the limbs of the U-profile of the magnet yoke 1 in the direction of the shaft 3. The permanent magnets typically comprise ferrites and/or neodymium. Furthermore, the polarity of the first and second permanent magnets 9, 10 is opposed relative to the shaft 3. This is suitably the case so that the magnetic circuit 4 is configured via the magnet yoke 1 and the shaft 3. It is evident here also that the first spacing 6 between the magnet yoke 1 and the shaft 3 is smaller than the second spacing 7. A magnetic force is thereby formed which is acts against gravity and relieves the bearing and the shaft 3. Wear phenomena are advantageously avoided.

The diameter of the shaft 3 is, in particular, between 5 cm and 3 m. Similarly to the exemplary embodiment of FIGS. 1 and 2, the outer diameter of the magnet yoke 1 is 20% to 30% larger than the diameter of the shaft 3.

What is claimed is:

1. A device for supporting a shaft, the device comprising:
a magnet yoke surrounding the shaft and having a U-profile, wherein an opening of the U-profile faces toward the shaft, and
at least one first element configured to generate a magnetic circuit from the magnet yoke to the shaft,
wherein the shaft is mounted eccentrically in the surrounding magnet yoke such that a first vertical upper spacing between the shaft and the magnet yoke is smaller than a second vertical lower spacing between the shaft and the magnet yoke.

2. The device of claim 1, wherein the at least one first element comprises a ring-shape coil arranged within the opening of the U-profile of the magnet yoke around the shaft.

3. The device of claim 1, wherein the at least one first element comprises first and second permanent magnets that attach to first and second radially arranged limbs, respectively, of the U-profile of the magnet yoke.

4. The device of claim 3, wherein a poling of the first permanent magnet at the first limb are opposed to a poling of the second permanent magnet at the second limb.

5. The device of claim 1, comprising a second element configured to displace the magnet yoke relative to the shaft.

6. The device of claim 5, wherein the second element is firmly attached to the magnet yoke.

7. The device of claim 1, wherein the first vertical upper spacing and the second vertical lower spacing are filled with a fluid.

8. The device of claim 7, wherein the first vertical upper spacing and the second vertical lower spacing are filled with air.

9. The device of claim 1, comprising a control unit configured to regulate the magnetic circuit, and adjust the first vertical upper spacing and the second vertical lower spacing.

10. An assembly, comprising:
a shaft,
a magnet yoke surrounding the shaft and having a U-profile, wherein an opening of the U-profile faces toward the shaft, and
at least one first element configured to generate a magnetic circuit from the magnet yoke to the shaft,
wherein the shaft is mounted eccentrically in the surrounding magnet yoke such that a first vertical upper spacing between the shaft and the magnet yoke is smaller than a second vertical lower spacing between the shaft and the magnet yoke.

11. The assembly of claim 10, wherein the at least one first element comprises a ring-shape coil arranged within the opening of the U-profile of the magnet yoke around the shaft.

12. The device of claim 10, wherein the at least one first element comprises first and second permanent magnets that attach to first and second radially arranged limbs, respectively, of the U-profile of the magnet yoke.

13. The device of claim 12, wherein a poling of the first permanent magnet at the first limb are opposed to a poling of the second permanent magnet at the second limb.

14. The device of claim 10, comprising a second element configured to displace the magnet yoke relative to the shaft.

15. The device of claim 14, wherein the second element is firmly attached to the magnet yoke.

16. The device of claim 10, wherein the first vertical upper spacing and the second vertical lower spacing are filled with a fluid.

17. The device of claim 16, wherein the first vertical upper spacing and the second vertical lower spacing are filled with air.

18. The device of claim 10, comprising a control unit configured to regulate the magnetic circuit, and adjust the first vertical upper spacing and the second vertical lower spacing.
